(19) United States
(12) Patent Application Publication
(10) Pub. No.: US 2012/0250174 A1
(43) Pub. Date: Oct. 4, 2012

(54) INFORMATION RECORDING DEVICE AND INFORMATION RECORDING METHOD

(75) Inventors: Kozo SUEISHI, Kawasaki-shi (JP); Akihiro HARIGAE, Ome-shi (JP)

(73) Assignee: KABUSHIKI KAISHA TOSHIBA, Tokyo (JP)

(21) Appl. No.: 13/323,293

(22) Filed: Dec. 12, 2011

(30) Foreign Application Priority Data
Mar. 30, 2011 (JP) 2011-076447

(51) Int. Cl. G11B 27/36

(52) U.S. Cl. 360/31; G9B/27.052

(57) ABSTRACT

According to one embodiment, an information recording device includes: a magnetic recording medium having tracks; a detector configured to detect widths of fringing phenomena that occur on both sides, in a track arrangement direction, of a track during recording on the track; and a recording controller configured to control recording so that adjacent tracks overlap with each other and that a track pitch is set at least on the basis of a smaller one of the detected fringing widths and a data read width for reading of data from the track.

### CROSS REFERENCE TO RELATED APPLICATION(S)

The application is based upon and claims the benefit of priority from Japanese Patent Application No. 2011-076447 filed on Mar. 30, 2011, the entire contents of which are incorporated herein by reference.

### BACKGROUND

1. Field

Embodiments of the present invention relates to an information recording device and an information recording method for recording information on a recording medium.

2. Description of the Related Art

In recent years, various techniques have been developed to increase the recording capacity of a magnetic disk device (hereinafter also referred to as HDD) which is an information recording device. Among these techniques is a recording technique called a shingled write recording method. The shingled write recording method is a recording method in which information is recorded on a magnetic disk in such a manner that a recording track overlaps with a part of an adjacent track. In the conventional recording method that is employed commonly in HDDs, it is difficult to increase the TPI (tracks per inch) because adjacent tracks have a prescribed gap. The shingled write recording method makes it possible to increase the TPI.

In HDDs, fringing may occur in which during recording on a track recording magnetic field of a head or magnetization transition leaks to an adjacent track. And fringing may destroy magnetically recorded information. The influence of fringing becomes less negligible as the TPI increases. Therefore, conventionally, a track pitch is determined taking the influence of fringing into consideration. In one method, a track pitch is determined in such a manner that by evaluating the degrees of influence of fringing phenomena from adjacent tracks to a track concerned by performing recording on both sides in the track arrangement direction in such a manner that the recording point gradually comes closer to or goes away from the track concerned.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing the configuration of an electronic apparatus which is equipped with a magnetic disk device (HDD) as an information recording device according to an embodiment;

FIG. 2 is a flowchart of a track pitch determination process which is executed in the HDD according to the embodiment to determine a track pitch based on the influence of fringing that occurs during recording;

FIGS. 3A and 3B are conceptual diagrams illustrating modes of shingled write recording to which a track pitch and a recording direction that are determined by the track pitch determination process according to the embodiment are applied;

FIG. 4 is a schematic diagram illustrating modes of influence of fringing that occurs on the recording surface of the magnetic disk of the HDD according to the embodiment;

FIG. 5 is a schematic diagram showing a specific example of shingled write recording processing performed at an arbitrary position on the recording surface of the magnetic disk of the HDD according to the embodiment; and

FIG. 6 is a schematic diagram showing another specific example of shingled write recording processing performed at an arbitrary position on the recording surface of the magnetic disk of the HDD according to the embodiment.

### DETAILED DESCRIPTION

According to one embodiment, an information recording device includes: a magnetic recording medium having tracks; a detector configured to detect widths of fringing phenomena that occur on both sides, in a track arrangement direction, of a track during recording on the track; and a recording controller configured to control recording so that adjacent tracks overlap with each other and that a track pitch is set at least on the basis of a smaller one of the detected fringing widths and a data read width for reading of data from the track.

An embodiment will be hereinafter described with reference to the drawings.

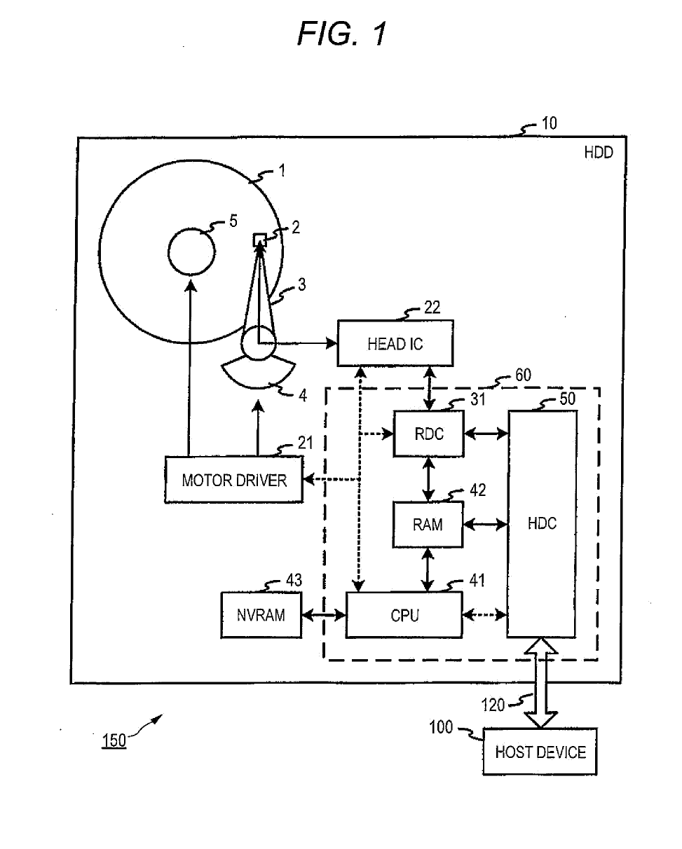

FIG. 1 is a block diagram showing the configuration of an electronic apparatus 150 which is equipped with a magnetic disk device (hereinafter also referred to as HDD) 10 as an information recording device according to the embodiment. The electronic apparatus 150 is also equipped with a host device 100. The HDD 10 is connected to the host device 100 via a communication medium (host I/F) 120 and functions as a storage module of the host device 100. The host I/F 120 connects the host device 100 and the HDD 10 and is used for communications for exchanging data and commands between the host device 100 and the HDD 10. For example, the electronic apparatus 150 is a personal computer and the host device 100 is chip set ICs of the personal computer.

The HDD 10 according to the embodiment is equipped with mechanism components such as a magnetic disk 1, a slider 2, an arm 3, a VCM (voice coil motor) 4, and an SPM (spindle motor) 5. The HDD 10 is also equipped with circuit blocks such as a motor driver 21, a head IC 22, an NVRAM 43, and a controller 60. The controller 60 includes a read/write channel IC (hereinafter also referred to as RDC) 31, a CPU 41, a RAM 42, and an HDC (hard disk controller) 50.

In the HDD 10 according to the embodiment, information is recorded on the recording surface of the magnetic disk 1 by a write head (not shown) which is provided on the slider 2. To record information on the recording surface of the magnetic disk 1, the recording technique called a shingled write recording method is used. The shingled write recording method is a recording method in which recording is performed on a track defined on the magnetic disk 1 in such a manner that overwriting is performed on part of an adjacent track (partial overwriting). The track pitch, which is the distance between the center of a certain track in the track arrangement direction and the center, in the same direction, of an adjacent track on which overwriting is to be performed, is determined on the basis of the influence of fringing that occurs at the time of recording.

Fixed to the SPM 5, the magnetic disk 1 is rotated being driven by the SPM 5 rotationally. At least one surface of the magnetic disk 1 is a recording surface on which information is recorded magnetically. That is, the magnetic disk 1 is a magnetic recording medium. For example, plural concentric tracks are defined on the recording surface and each track has servo regions and data regions. Physical address information on the recording surface of the magnetic disk 1 is recorded in each servo region. Information to be recorded in the HDD 10 is recorded in data regions. In the embodiment, the shingled write recording method is employed as a method for recording information in data regions of the magnetic disk 1.

The slider 2 is provided at one end of the arm 3 so as to be opposed to the recording surface of the magnetic disk 1. The slider 2 is provided with a read head and a write head (neither of which is shown). The read head reads a signal that is magnetically recorded on the recording surface of the magnetic disk 1. The read-out signal is output to the head IC 22 via conductor patterns formed on the arm 3. The write head magnetically records, on the recording surface of the magnetic disk 1, a write signal (write current) that is input from the head IC 22 via conductor patterns formed on the arm 3.

The arm 3 is provided with the slider 2 at one end and with a bearing portion 3a at the other end. The arm 3 is rotated with the bearing portion 3a as a rotation center according to a drive current that is supplied to the VCM 4, and thereby moves the slider 2 in the radial direction over the recording surface of the magnetic disk 1.

The VCM 4 is driven according to a drive signal (current) that is supplied from the motor driver 21, and thereby rotates the arm 3.

The SPM 5 is driven according to a drive signal (current) that is supplied from the motor driver 21, and thereby rotates the magnetic disk 1.

The motor driver 21 supplies the VCM 4 and the SPM 5 with drive signals (currents) for driving them on the basis of control signals supplied from the controller 60 (more specifically, CPU 41), respectively.

The head IC 22 amplifies a signal that is input from the read head of the slider 2 via the conductor patterns formed on the arm 3, and outputs an amplified signal to the controller 60 (more specifically, RDC 31) as read information. Furthermore, the head IC 22 outputs a write signal (write current) corresponding to recording information that is input from the controller 60 (more specifically, RDC 31), to the write head of the slider 2 via the conductor patterns formed on the arm 3.

The controller 60 is an SoC (system on chip) including the RDC 31, the CPU 41, the RAM 42, the HDC 50, etc. An alternative configuration is possible in which the controller 60 does not include the RAM 42 and the RAM 42 is provided outside and connected to the controller 60. The controller 60 performs information recording processing for recording information on plural bands and boundary tracks defined on the recording surface of the magnetic disk 1.

The RDC 31 decodes read information that is input from the head IC 22 by performing prescribed processing on it, and outputs resulting decoded information to the HDC 50. Furthermore, the RDC 31 encodes recording subject information that is input from the HDC 50 by performing prescribed processing on it, and outputs resulting coded information to the head IC 22 as recording information. The RDC 31 detects servo intervals, indicating servo regions, from the read information, and extracts pieces of position information from signals in the detected servo intervals. The extracted pieces of position information are output to the CPU 41. The RDC 31 uses the RAM 42 as a work memory in performing the above pieces of processing.

The CPU 41 is a processor for controlling the individual blocks of the HDD 10 by running programs stored in the NVRAM 43. For example, the CPU 41 controls operations of rotating the VCM 4 and the SPM 5 and recording information on the magnetic disk 1. The CPU 41 runs a program for causing the controller 60 to operate as a servo controller or a read/write controller. In running such a program, the CPU 41 uses the RAM 42 as a work memory. In the embodiment, the controller 60 controls data quality evaluation processing of reading information from the magnetic disk 1 and performing an error rate measurement, for example. When the controller 60 operates as a read/write controller, information is recorded on the magnetic disk 1 by the shingled write recording method. Furthermore, the controller 60 controls track pitch determination processing of determining an interval between the centers of adjacent tracks in the track arrangement direction (track pitch) on the basis of the influence of fringing that occurs during recording.

The RAM 42 is a work memory for the RDC 31, the CPU 41, and the HDC 50. The RAM 42 is a DRAM which is a volatile memory.

The NVRAM 43 is a nonvolatile memory for storing the programs to be run by the CPU 41. The programs stored in the NVRAM 43 can be updated. The NVRAM 43 also stores parameter values to be used in processing performed by the CPU 41.

The HDC 50 performs communication processing of transmitting and receiving information to and from the host device 100. The HDC 50 encodes decoded information that is input from the RDC 31 by performing prescribed processing on it, and transmits resulting coded information to the host device 100 as transmission information. The HDC 50 decodes reception information received from the host device 100 by performing prescribed processing on it, and outputs resulting decoded information to the RDC 31 as recording subject information. For example, the HDC 50 performs communication processing that complies with the SATA (serial advanced technology attachment) standard to communicate with the host device 100. When receiving, from the host device 100, a write command containing information indicating a logical address from which to start data recording and a recording data length, the HDC 50 extracts the information indicating the logical address and the recording data length from the received write command and outputs the extracted information indicating the logical address and the recording data length to the CPU 41.

In the above-configured HDD 10 according to the embodiment, information is recorded on plural tracks by the plural blocks of the HDD 10 at a prescribed track pitch by the shingled write recording method. The track pitch is determined so as to be a smaller value by the track pitch determination processing on the basis of the influence of fringing that occurs during recording. That is, in the HDD 10 according to the embodiment, a smaller track pitch can be set in recording information by the shingled write recording method.

Next, a track pitch determination process which is executed in the HDD 10 according to the embodiment to determine a track pitch on the basis of the influence of fringing that occurs during recording.

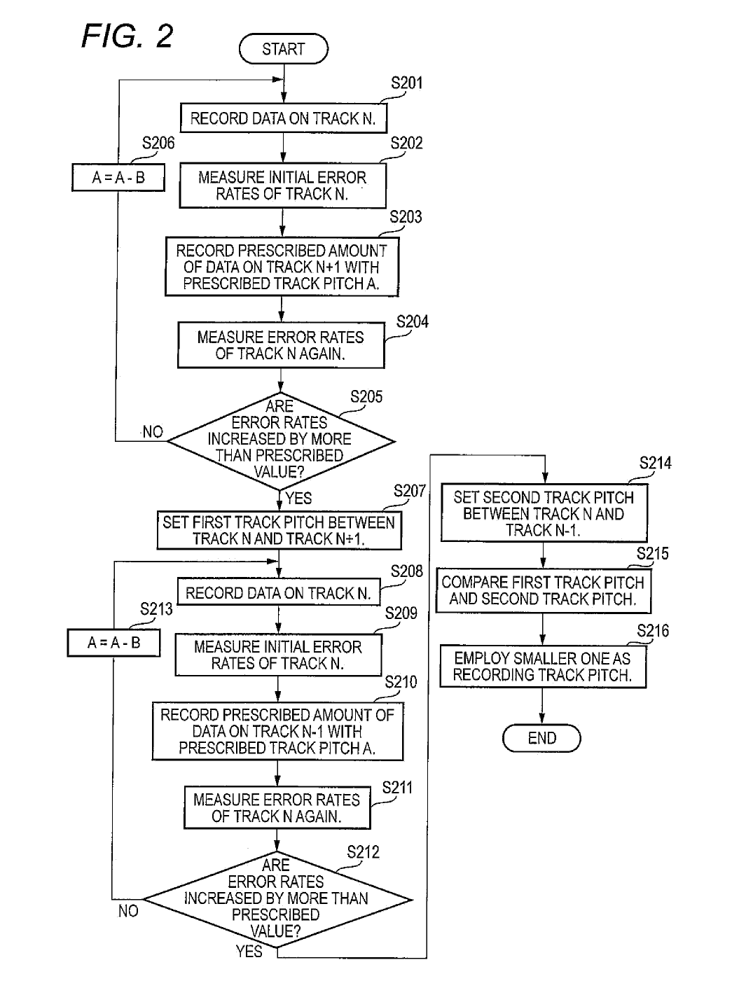

FIG. 2 is a flowchart of the track pitch determination process which is executed in the HDD 10 according to the embodiment to determine a track pitch on the basis of the influence of fringing that occurs during recording.

The track pitch determination process is controlled by the CPU 41 which operates as a read/write controller. The track pitch determination process determines not only a track pitch but also a recording direction of a shingled write recording operation. First, at step S201, the read/write controller records data on track N. The data may be any data that enables error rate measurement. At step S202, the read/write controller measures error rates of the respective sectors of track N on which the data has been recorded. The measured error rates are stored in a memory (storage unit) such as the RAM 42 as initial error rates ERdef of the respective sectors.

At step S203, the read/write controller records, with a track pitch A, a prescribed amount of data on track N+1 which is adjacent to track N. At this time point, the track pitch A is equal to a prescribed measurement start value Astart. The prescribed amount of data may have a data amount that enables measurement of error rates of several sectors, for example. Upon completion of the recording of the prescribed amount of data, at step S204 the read/write controller again measures error rates of the sectors of track N that are adjacent to the data-recorded sectors of track N+1. At step S205, the read/write controller judges whether or not the measured error rates are higher than the respective initial error rates ERdef by more than a prescribed value.

If the measured error rates are not increased by more than the prescribed value (S205: no), at step S206 the read/write controller updates the track pitch A to the current track pitch A minus a subtraction value B (A=A−B). Then, the read/write controller again performs the series of steps of recording data on track N (S201), measuring initial error rates of the data-recorded track N (S202), recording a prescribed amount of data on track N+1 with the updated track pitch A (S203), and measuring error rates of track N again (S204).

On the other hand, if the measured error rates are increased by more than the prescribed value (S205: yes), at step S207 the read/write controller stops the recording being performed and stores the track pitch A that was employed immediately before the last update in the memory as a first track pitch in the direction from track N+1 to track N. In other words, the width of influence of fringing occurring in the direction from track N+1 to track N in recording data on track N+1 is determined.

Then, the read/write controller performs processing of setting a track pitch between track N and track N−1 that is adjacent to track N on the side opposite to track N+1. This processing is equivalent to the processing of setting a track pitch between track N and track N+1. At step S208, the read/write controller records data on track N gain. At step S209, the read/write controller measures error rates of the respective sectors of track N on which the data has been recorded. The measured error rates are stored in the memory (storage unit) as initial error rates ERdef of the respective sectors.

At step S210, the read/write controller records, with a track pitch A, a prescribed amount of data on track N−1 which is adjacent to track N. At this time point, the track pitch A is equal to the prescribed measurement start value Astart. Upon completion of the recording of the prescribed amount of data, at step S211 the read/write controller again measures error rates of the sectors of track N that are adjacent to the data-recorded sectors of track N−1. At step S212, the read/write controller judges whether or not the measured error rates are higher than the respective initial error rates ERdef by more than the prescribed value.

If the measured error rates are not increased by more than the prescribed value (S212: no), at step S213 the read/write controller updates the track pitch A to the current track pitch A minus the subtraction value B (A=A−B). Then, the read/write controller again performs the series of steps of recording data on track N (S208), measuring initial error rates of the data-recorded track N (S209), recording a prescribed amount of data on track N−1 with the updated track pitch A (S210), and measuring error rates of track N again (S211).

On the other hand, if the measured error rates are increased by more than the prescribed value (S212: yes), at step S214 the read/write controller stops the recording being performed and stores the track pitch A that was employed immediately before the last update in the memory as a second track pitch in the direction from track N−1 to track N. In other words, the width of influence of fringing occurring in the direction from track N−1 to track N in recording data on track N+1 is determined.

At step S215, the read/write controller compares the first track pitch and the second track pitch. At step S216, the read/write controller determines that a smaller one should be employed as a recording track pitch. And the read/write controller determines that the direction of a larger one should be employed as a recording direction of shingled write recording processing. Once a recording track pitch has been determined by the track pitch determination process, shingled write recording is performed in such a manner that a track is overwritten on the side of the larger track pitch. In other words, after determination of a recording track pitch, shingled write recording is performed in such a manner that a track is overwritten on the side of a larger width of influence of fringing.

The recording track pitch and the recording direction that have been determined by the track pitch determination process need not be used on the entire recording surface of the magnetic disk 1. For example, it is possible to divide the recording surface of the magnetic disk 1 into plural areas in the radial direction and determine a recording track pitch and a recording direction for each divisional area. Each determined set of recording track pitch and a recording direction is used for shingled write recording processing performed in a corresponding area.

The above track pitch determination process is just an example, and a track pitch may be determined by another method. For example, the reliability of data may be evaluated on the basis of Viterbi metric margins (VMMs) or reproduction signal levels rather than error rates.

In the HDD 10 according to the embodiment, the track pitch determination process is executed according to the above procedure. In this process, a track pitch and a recording direction of shingled write recording are determined on the basis of widths of influence of fringing phenomena to occur on both sides of a certain track. That is, the embodiment makes it possible to set a smaller track pitch by taking into consideration the influence of fringing from only one side for information recording by the shingled write recording method.

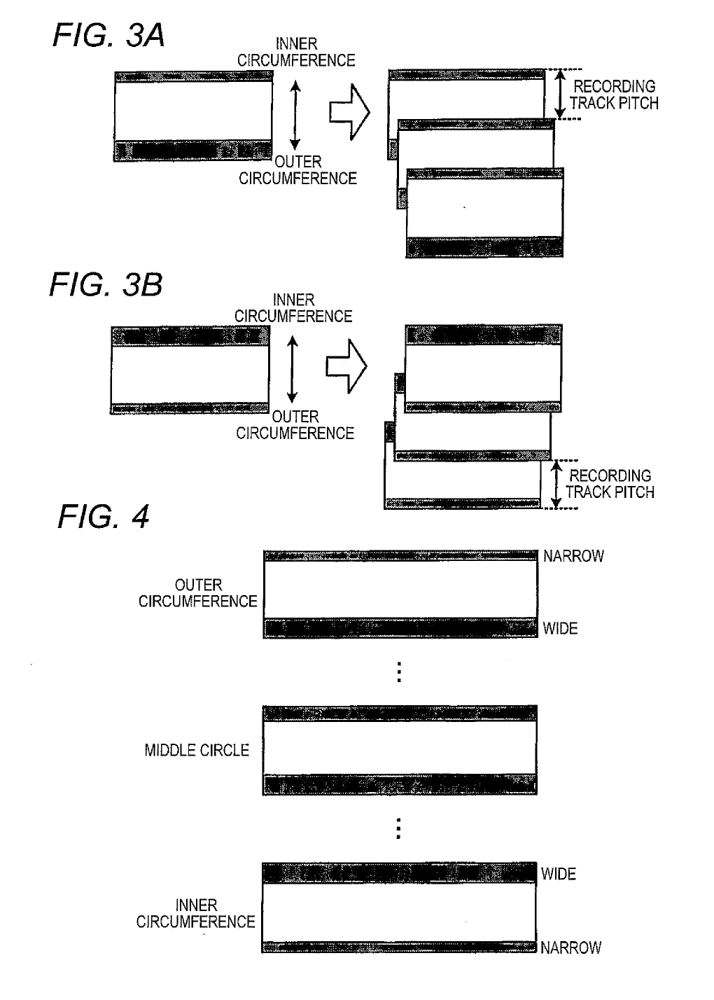

Next, modes of shingled write recording to which a track pitch and a recording direction that are determined by the track pitch determination process according to the embodiment are applied will be described with reference to FIGS. 3A and 3B.

FIGS. 3A and 3B are conceptual diagrams illustrating modes of shingled write recording to which a track pitch and a recording direction that are determined by the track pitch determination process according to the embodiment are applied.

The conceptual diagram of FIG. 3A shows a mode in which the width, in the track arrangement direction, of influence of fringing that occurs at the time of recording on a certain track is small on the inner circumference side and large on the outer circumference side. In this mode, a track pitch between adjacent tracks is set at least on the basis of a data read width for reading of data from a track and a smaller fringe width on the inner circumference side. Shingled write recording processing is performed in such a manner that a track is overwritten in the direction toward the outer circumference.

The conceptual diagram of FIG. 3B shows a mode in which the width, in the track arrangement direction, of influence of fringing is large on the inner circumference side and small on the outer circumference side. In this mode, a track pitch between adjacent tracks is set at least on the basis of a data read width for reading of data from a track and a smaller fringe width on the outer circumference side. Shingled write recording processing is performed in such a manner that a track is overwritten in the direction toward the inner circumference.

As described above, in the track pitch determination process according to the embodiment, a track pitch and a recording direction of shingled write recording are determined on the basis of fringing widths on both sides of a certain track. For example, if the track pitch determination process is executed at an arbitrary position on the recording surface of the magnetic disk 1 of the HDD 10 according to the embodiment, shingled write recording processing can be performed with a track pitch and a recording direction that are suitable for the arbitrary position.

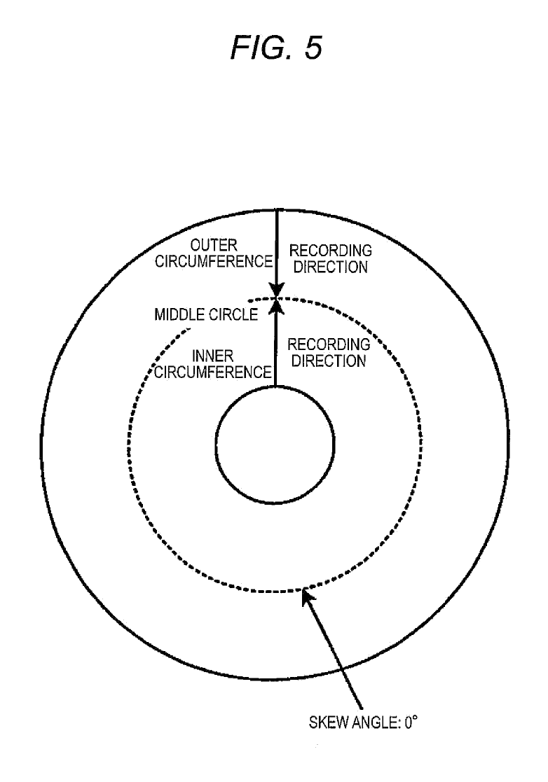

Next, specific examples of shingled write recording processing to which a track pitch and a recording direction that are suitable for an arbitrary position on the recording surface of the magnetic disk 1 are applied will be described with reference to FIGS. 4 and 5.

FIG. 4 is a schematic diagram illustrating modes of influence of fringing that occurs on the recording surface of the magnetic disk 1 of the HDD 10 according to the embodiment. FIG. 5 is a schematic diagram showing a specific example of shingled write recording processing performed at an arbitrary position on the recording surface of the magnetic disk 1 of the HDD 10 according to the embodiment.

In the HDD 10 according to the embodiment, the skew angle which is the angle between a track defined on the recording surface of the magnetic disk 1 and the read head or the write head of the slider 2 varies depending on the position on the recording surface. For example, there may occur a case that the skew angle is 0° in a middle area, in the radial direction, of the recording surface and have prescribed angles in an inner-circumference-side area and an outer-circumference-side area, respectively. The width of influence of fringing in the track arrangement direction varies depending on the skew angle.

More specifically, as shown in the schematic diagram of FIG. 4, in a track located in a middle area, in the radial direction, of the recording surface of the magnetic disk 1, the widths of influence of fringing phenomena that occur on both sides of the track are approximately the same . On the other hand, in a track close to the outer circumference the recording surface, the width of influence of fringing occurring is large on the inner circumference side and small on the outer circumference side. In a track close to the inner circumference the recording surface, the width of influence of fringing occurring is small on the inner circumference side and large on the outer circumference side. This tendency can be confirmed by executing the track pitch determination process according to the embodiment around three kinds of tracks as shown in FIG. 4. Where fringing occurs in the manner shown in FIG. 4, in an area that is located on the inner circumference side of a middle circle, it would be determined that shingled write recording processing should be performed in the direction from the inner circumference to the middle circle (see the schematic diagram of FIG. 5). In an area that is located on the outer circumference side of the middle circle, it would be determined that shingled write recording processing should be performed in the direction from the outer circumference to the middle circle.

The above method of executing the track pitch determination process at plural positions on the recording surface of the magnetic disk 1 of the HDD 10 according to the embodiment makes it possible to perform shingled write recording processing with a track pitch and a recording direction that are suitable for each position on the recording surface.

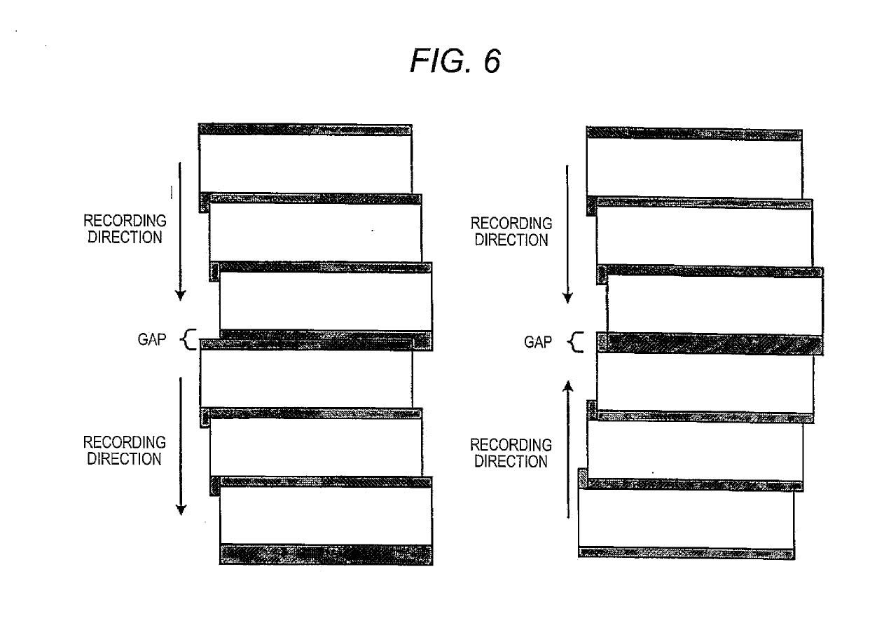

Next, another specific example of shingled write recording processing to which a track pitch and a recording direction that are suitable for each position on the recording surface are applied will be described with reference to FIG. 6.

FIG. 6 is a schematic diagram showing another specific example of shingled write recording processing performed at an arbitrary position on the recording surface of the magnetic disk 1 of the HDD 10 according to the embodiment.

In the embodiment, the recording surface of the magnetic disk 1 is divided into plural areas in the track arrangement direction and shingled write recording processing is performed independently in each divisional area. Pieces of shingled write recording processing that are performed in adjacent ones of the plural divisional areas may have either the same recording direction or different recording directions. In either case, two tracks that are adjacent to each other across the boundary of adjacent areas are joined to each other with a gap that corresponds to fringing widths of the two adjacent tracks. More specifically, as shown in the schematic diagram of FIG. 6, two tracks that are adjacent to each other across the boundary of adjacent areas are joined to each other with a gap that is equal to a larger one of fringing widths, occurring on the respective boundary sides, of the two adjacent tracks. This applies irrespective of whether pieces of shingled write recording processing that are performed in the adjacent areas have the same recording direction or different recording directions. Although it is preferable that the gap between two tracks that are adjacent to each other across the boundary of adjacent areas be equal to a larger fringing width (see FIG. 6), the gap may be set so as to be longer than or equal to the larger fringing width.

As described above, the track pitch determination process according to the embodiment makes it possible to determine not only track pitches of respective areas where shingled write recording processing is performed but also a minimum track pitch of the joining portion of adjacent areas. That is, the HDD 10 according to the embodiment makes it possible to set a smaller track pitch by taking into consideration the influence of fringing from only one side for information recording by the shingled write recording method.

As described above, shingled write recording processing is performed independently in each of plural divisional areas obtained by dividing the recording surface of the magnetic disk 1 in the track arrangement direction. In such shingled write recording processing, the track pitch determination process is executed to determine track pitches and recording directions of the respective divisional areas a minimum track pitch of the joining portion of each pair of adjacent areas. In the track pitch determination process, a smaller track pitch is determined on the basis of the influence of fringing that occurs at the time of recording on a track. Therefore, the HDD 10 according to the embodiment makes it possible to set a smaller track pitch by taking into consideration the influence of fringing from only one side for information recording by the shingled write recording method.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording device comprising:
a magnetic recording medium having tracks;
a detector configured to detect widths of fringing phenomena that occur on both sides, in a track arrangement direction, of a track during recording on the track; and
a recording controller configured to control recording so that a part of adjacent tracks overlap with each other and that a track pitch is set at least based on a smaller one of the detected fringing widths and a data read width for reading of data from the track.

2. The information recording device according to claim 1, wherein
the recording controller is configured to control recording so that the part of adjacent tracks overlap with each other and that the recording proceeds in a direction of a larger one of the detected fringing widths.

3. The information recording device according to claim 1, wherein
the recording controller is configured to control recording so that the part of adjacent tracks overlap with each other and that the recording proceeds in a direction from an inner circumference to a middle circle in an inner-circumference-side area of a recording area of the magnetic disk and in a direction from the outer circumference to the middle circle in an outer-circumference-side area of the recording area of the magnetic disk.

4. The information recording device according to claim 1, wherein:
the recording controller is configured to define a plurality of track groups including a plurality of tracks in which two tracks that are adjacent to each other across a boundary of adjacent track groups are joined to each other with a gap that is equal to a larger one of fringing widths of the two adjacent tracks.

5. An information recording method of an information recording device which is equipped with a magnetic recording medium having tracks, comprising:
detecting widths of fringing phenomena that occur on both sides, in a track arrangement direction, of a track during recording on the track; and
controlling recording so that a part of adjacent tracks overlap with each other and that a track pitch is set at least based on a smaller one of the detected fringing widths and a data read width for reading of data from the track.

6. The information recording method according to claim 5, wherein
the recording is controlled so that the part of adjacent tracks overlap with each other and that the recording proceeds in a direction of a larger one of the detected fringing widths.

7. The information recording device according to claim 5, wherein
the recording is controlled so that the part of adjacent tracks overlap with each other and that the recording proceeds in a direction from an inner circumference to a middle circle in an inner-circumference-side area of a recording area of the magnetic disk and in a direction from the outer circumference to the middle circle in an outer-circumference-side area of the recording area of the magnetic disk.

8. The information recording device according to claim 5, wherein:
in the controlling, a plurality of track groups is define, the plurality of track groups including a plurality of tracks in which two tracks that are adjacent to each other across a boundary of adjacent track groups are joined to each other with a gap that is equal to a larger one of fringing widths of the two adjacent tracks.
